(19) United States
(12) Patent Application Publication
(10) Pub. No.: US 2004/0203990 A1
(43) Pub. Date: Oct. 14, 2004

(54) Method and system for power control in mobile radio system

(76) Inventor: Rossella De Benedittis, Milano (IT)

Correspondence Address: BIRCH STEWART KOLASCH & BIRCH, PO BOX 747, FALLS CHURCH, VA, 22040-0747, US

(21) Appl. No.: 10/333,340

(22) PCT Filed: Jul. 20, 2001
(86) PCT No.: PCT/EP01/08431

(30) Foreign Application Priority Data
Jul. 28, 2000 (IT) MI2000A001748

(51) Int. Cl. H04B 7/00

(52) U.S. Cl. 455/522; 455/63.1

(57) ABSTRACT

The following invention defines a method of monitoring the power level in an uplink (i.e. from a mobile to a fixed station) transmission direction from a fixed station to mobile stations accessing it, facilitating the optimal transmission of mobile stations without the need for a two-way link with the fixed station. The method proposed is particularly appropriate during the network accessing phase, handover procedure or one-way transmission (e.g. packet transmissions), where there is not (yet) a two-way link between the fixed and mobile station. It should be noted that, for packet transmissions, the link can be exclusively one-way, in the sense that the data-flow takes place in one direction only (e.g. uplink). Given that the command for the monitoring of power in uplink derives from the access network and excludes the signal received from the mobile station to be monitored, the method described herein is particularly advantageous, although non-restrictive, for Frequency Division Duplex (FDD) frequency division radio access techniques, in which the characteristics of the propagation channel in uplink are generally separate from those in the downlink direction (i.e. from the fixed to the mobile station). The invention is applicable to digital mobile telecommunications systems, such as for example Global Mobile Systems (GSM) and, in particular, third-generation Universal Mobile Telecommunication Systems (UMTS) access technique cellular systems, in which power monitoring fulfils an important function for the optimal use of radio resources and hence the entire system capacity.

### DESCRIPTION OF INVENTION

The present invention relates to digital mobile telecommunications systems in which the reception/transmission of signals between two interactive radio units, respectively the mobile and fixed stations, is structured as a frame and the transmission direction is distinguished from the reception direction either in the time domain in accordance with the TDD (Time Division Duplex) access technique, or the frequency domain in accordance with the FDD (Frequency Division Duplex) access technique.

The frame comprises N time slots, within which the reception/transmission of the wanted signal occurs according to the TDMA (Time Division Multiple Access) access technique. For third-generation cellular digital systems, up to M signals and/or different users can be multiplexed by code division on each time slot according to the CDMA (Code Division Multiple Access) access technique.

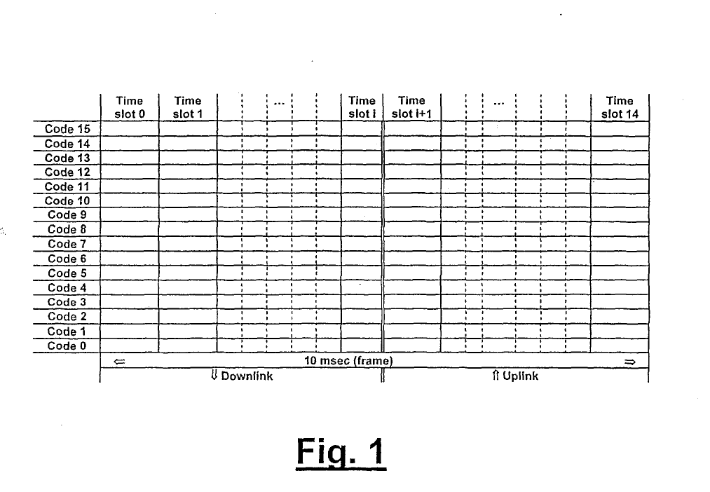

The triplet (time slot; code; frequency) defines a physical channel or radio resource. FIG. 1 shows an example of a frame structure for a TDD technique UMTS system. Even in the absence of traffic, a fixed station will always have at least one reference channel (broadcast channel) active for the sending of the necessary system information to the mobile stations to access the network services. This broadcast channel is issued at a constant power level, known a priori or signalled by the network through the system information. The presence of a reference channel issued at constant power allows the mobile stations to estimate the path loss of the radio link to the fixed station, without needing to interact with it. Before accessing a fixed station, the mobile station must have read and decoded all system information radiated by it. In cellular systems in general, and in particular third-generation systems using the CDMA radio access technique, the regulation of power in the transmitted signals has a fundamental role. The correct regulation of power allows a radio unit to issue the requisite power only, bringing energy savings (particularly important for mobile stations) and, in particular, reducing interference/disturbance caused by other system users or systems. For CDMA technique systems in which the limit on the available radio resources is, to a large extent, dependent on the level of suffered interference, it will be appreciated that a valid power regulation method is of prime importance.

### PRIOR ART

In the context of mobile-radio systems, two power control methods are currently in use, defined respectively as follows:

1. open-loop power control

2. closed-loop power control

Open-loop power control (method 1) does not incorporate a mechanism for the receiving unit (e.g. fixed station) to transmit all information to the transmitting unit (e.g. mobile station) to enable the latter to transmit at the appropriate power level; this means that the transmitting station autonomously defines the power level to be used on the basis of measurements taken from active channels in downlink from the interactive unit; broadcast channels, continuously available to guarantee the service and issued by fixed stations at a constant power level known a priori (or made known), are generally used for this purpose. Given that no interaction with the receiving unit is necessary, the method can be applied to any type of channel (two-way or one-way) and during any phase of the radio connection between the interacting entities (for example, before or after the initiation of the connection).

Closed-loop power control (method 2) means that the receiving unit (fixed or mobile station) sends the transmitting unit (respectively, mobile or fixed station) an absolute or corrective command concerning the power level to be transmitted thereafter. Given that there is provision for interaction between the two radio units, the method can only be applied if a radio connection has already been established between the two interacting units, catering for at least one two-way link.

The limitation of method 1 is that the transmitting unit does not take account of measurable parameters or parameters known only to the receiving unit, for example the level of interference detected on the physical channel which the transmitting unit is preparing to use, or corrective constants associated, for example, with radiation systems used; the use of such parameters would facilitate a more precise calculation of the power level to be emitted, thus optimising the power radiated and the probability of correct reception of the transmitted signal.

The principal restriction on method 2 is that it can only be applied if a connection is already active and this connection includes at least one two-way link. For this reason, this method cannot be applied during a handover or for one-way connections or during the access phase.

A first attempt to solve the main problem outlined in the open-loop power control is disclosed in the U.S. Pat. No. 5,278,992, filed on Nov. 8, 1991 concerning a CDMA-TDD digital cordless phone system. In particular it's textually claimed that the transmission power of the remote transmitted signal is controlled in accordance with the following expression (implicitly expressed in dBm):

Power=A+(B−C),

where A is representative of the desired power of the remote transmitted signal received by the base device; B is representative of the power of the base transmitted signal, transmitted by the base device; and C is representative of the measured power of the base transmitted signal as received by the remote device. Although this approach introduce a remarkable progress, it suffers the drawback do not consider the effect of the interferences in the expression of the power parameter A. The bracket term (B−C) is the path loss in downlink calculated by the mobile station on the basis of the implicit knowledge of the term B and the reading of the term A which is broadcasted by the base station on a control channel.

The article of Masato Tanaka, Seiuchi Sampei, and Norihiko Morinaga, titled “Fast Initial Acquisition of Transmitter Power for the Reverse Link DS/CDMA Cellular Systems”, published on IEEE, 1998, discloses a CIR-based TPC (Carrier-to-Interference power Ratio)-based (Transmitter Power Control) that fills the gap highlighted in the preceding term A, now expressed as:

(Rx_{t arg et})ⁿⱼ=(CIR)_{t arg et}×Iⁿⱼ

where: n indicates the n-th timeslot, j indicates the j-th base station, and Iⁿⱼ is the interference signal level on the n-th timeslot averaged for all the mobile stations connected to the j-th base station. Term (Rx_{t arg et})ⁿⱼ is broadcasted by the base station. The teaching of this article introduces an undoubted progress in the open-loop power control, nonetheless the control is not yet optimal mainly because the used interference is quite generic.

From the foregoing we see that the power control methods currently in use do not allow a perfect setting of the mobile system transmit power level either because the accessed network does not send all information needed by the mobile system, like for the open loop power control methods where the network signals the broadcast channel power and eventually a generic interference level only, or for the closed loop power control methods which require an already established duplex connection between the interacting radio endpoints.

### OBJECTS OF THE INVENTION

The object of the present invention is to overcome the drawbacks described above, typical of the prior art, and identify a method and mechanism for the regulation of the power level in the uplink (i.e. from the mobile to the fixed station) transmission direction by a fixed station towards the mobile stations accessing it, thus optimising transmission from the mobile stations without the prerequisite of a two-way link with the fixed station.

### SUMMARY OF THE INVENTION

The method of the present invention incorporates the two above mentioned power control methods currently in use (i.e. the open-loop power control and the closed-loop power control) and is applicable to any type (two-way or one-way) and any state (access phase; connected phase or handover phase) of the connection and also takes account of parameters known only to the receiving radio unit.

The present invention relates to a method realised in accordance with the description given in claim 1.

The present invention applies to digital mobile telecommunications systems in which the transmission and reception of signals between two interactive radio units, respectively the mobile and fixed stations, is structured as a frame and the transmission direction is distinguished from the reception direction either in the time domain in accordance with the TDD (Time Division Duplex) access technique, or the frequency domain in accordance with the FDD (Frequency Division Duplex) access technique and, in particular, to third-generation CDMA (Code Division Multiple Access) radio access technique cellular systems, in which the invention defines a method for the regulation of the power level in the uplink (i.e. from the mobile to the fixed station) transmission direction by the radio access network towards the mobile stations accessing it, thus optimising the transmission of mobile stations without the prerequisite of a two-way link with the fixed station. The method referred to in the invention takes account of parameters known or measurable from the fixed station only which impact strongly on the definition of the correct power level to be transmitted by the mobile stations, including, for example, the interference level and the quality parameters required for the information flow carried on the specific physical channel on which the mobile station will be transmitting such that, by using this information which under the control of the network only and adding the information which is under control of the mobile station only, like for instance the radio link attenuation, the mobile station can access to the network with the correct power level as if a perfect closed loop power control was running.

Contrarily to the article of Masato Tanaka et al. in which the used interference is generic the method of this invention allows the mobile system to have all needed information for a perfect transmit power level setting, which are: the exact expected power level at the accessing network based on the knowledge of which physical channel and which specific information (and therefore the expected quality) the mobile station is going to use, and the mobile system specific parameters like the radio link attenuation and local transmitter parameters, before the accessing mobile system is known at the accessed network.

### BRIEF DESCRIPTION OF FIGURES

Additional advantageous characteristics of the present invention will become evident from the description given below, with reference, by way of example only and without restriction, to FIG. 1, attached, which shows an example of a frame structure for a TDD-CDMA access technique system.

### DESCRIPTION OF A PREFERRED FORM OF REALISATION OF THE INVENTION

Considering that:

the mobile-radio unit must, before being capable of accessing the network, read and decode all system information emitted by the fixed station selected through its broadcast channel,

the mobile station knows (a priori or because reported in the system information) the power level at which the selected fixed station emits its broadcast channel and is therefore able to divert the Path_Loss to that fixed station, for example, by subtracting from the power with which the fixed station transmits its broadcast channel the power with which the mobile station receives this broadcast channel,

the mobile station knows (a priori or because reported in the system information) which physical channels have been configured to send the first access signals to the network;

An initial phase of the invention described herein proposes that, in addition to the stipulated system information, the network also sends over the broadcast channel the expected power level to be received by the mobile stations accessing the assigned physical channel(s) to be used to send the first access signal, according to the following law:

Rx_{—}PL=SIRtarget+I+K1 (1)

Where:

Rx_PL: indicates the network expected power level (in dBm) on the specific physical channel from the mobile station;

SIRtarget: indicates the ratio (in dB) between the wanted signal and the interfering signal required for the correct reception of the type of message/signal expected on the specific physical channel; this parameter may be configured by the operator or calculated/optimised on the basis of statistical data obtained from the network during service,

I: indicates the level of interference (in dBm) measured by the fixed station on the physical channel which will be used by the accessing mobile system to send the first access signal;

K1: is a corrective constant which includes, by way of example, the antenna gain on the fixed station; corrections, if any, of the power level on the broadcast channel, assumed to be known to the mobile station; correction factors for possible measurement inaccuracies, etc., etc.

The mobile station is thus able to define the power level with which to send the first access signal on the physical channel to be used by the network for this purpose, applying the following formula:

Tx_{—}PL=Rx_{—}PL+Path_Loss+K2 (2)

Where:

Tx_PL: indicates the power level with which the mobile station transmits the first access signal to the selected fixed station;

Rx_PL: indicates the expected power level from the fixed station on the specific physical channel, calculated in the fixed station according to law (1) and sent by it in broadcast;

K2: is a corrective constant which takes into account, for example, factors concerning inaccurate measurements in the mobile station etc., etc.

A second phase of the invention described herein proposes that, in response to an initial signal or access request and, in general, whenever a fixed station sends a dedicated message to a mobile station, knowing on which new physical channel this mobile station will transmit following the receipt of the above message, the fixed station will include in that message information on the expected power level from the mobile station on that new physical channel. The expected power level will be calculated by the fixed station which will host the new physical channel (which, for handover, may be different from the fixed station sending the above message), adapting the interference parameters I and the SIRtarget parameter respectively to the interference value measured on the new physical channel and the type of information to flow on it.

The above message may, for example, be an assignment message for a channel to initiate a connection, if given in response to an initial access request, or a handover message, if the connection has been established, but has to occupy new physical channels. In the latter case, if the handover takes place vis-à-vis a fixed station other than the currently serving station, the content of the hand-over message must be compiled by the recipient fixed station.

As a further extension of the invention in the case of an assignment by handover of a new physical channel belonging to the currently serving station, the fixed station may also indicate in the assignment message the power level at which the assignment message is being transmitted; this information may then be used by the mobile station to calculate the path loss, a prerequisite for a definition of the optimal power level to be used in the transmission, without having to read (apart from currently active connection channels) the broadcast channel of that fixed station.

1. Method for regulating the power of a radio signal transmitted uplink by at least a mobile station towards a fixed station of a digital cellular network employing physical radio channels defined by a triplet of frequency, timeslot, and code for the transmission and reception of signals between interacting stations, including the following steps:
the fixed station measures the power of the interference I on the uplink physical channel used by the mobile station to send the first access signal;
the fixed station calculates a logarithmic target parameter SIRtarget indicating the ratio between the power level expected in uplink and the power level of the interference;
the fixed station calculates an expectation parameter Rx_PL for indicating the expected power level on the specific uplink channel used by the mobile station for communicating with the network, by adding the target parameter SIRtarget to the logarithmic power of the interference I measured on said specific uplink physical channel;
the fixed station transmits said expectation parameter Rx_PL on the broadcast channel;
the mobile station sets a transmission power level Tx_PL by adding the received expectation parameter Rx_PL to the logarithm of the Path_Loss measured by the mobile station assuming as known the power level transmitted on said broadcast channel;
the mobile station accesses the network using the power level Tx_PL,
characterised in that:
the SIRtarget parameter calculated by the fixed station is the one required for the correct reception of the type of message/signal expected on said specific uplink physical channel.

2. Method in accordance with claim 1, characterised in that said target parameter SIRtarget is calculated/optimised on the basis of statistical data obtained from the network during service.

3. Method in accordance with claim 1 or 2, characterised in that a first corrective constant K1 is added to said expectation parameter Rx_PL to take account for the antenna gain of the fixed station, and/or corrections of the power level of the signal transmitted on said broadcast channel, and/or corrections for possible measurement inaccuracies.

4. Method in accordance with one of the preceding claims, characterised in that a second corrective constant K2 is added to said transmission power level Tx_PL to take account for inaccurate measurements in the mobile station.

5. Method in accordance with one of the preceding claims, characterized in that the physical channels are structured into continuously repeated basic frames, and the transmission direction is distinguished from the reception direction in the time domain in accordance with the TDD, Time Division Duplex, access technique.

6. Method in accordance with any claim from 1 to 4, characterized in that the physical channels are structured into continuously repeated basic frames, and the transmission direction is distinguished from the reception direction in the frequency domain in accordance with the FDD, Frequency Division Duplex, access technique.

7. Method in accordance with one of the preceding claims, characterized in that said power control is performed during: the initiation state, the access phase, the connection phase, the handover phase.

8. Method in accordance with the preceding claim, characterised in that the network in response to an access request issued by the mobile station, or autonomously, sends a dedicated message to the mobile station with the indication to switch to a new assigned physical channel, and the further indication of the expectation parameter Rx_PL for that new physical channel, as calculated by the fixed station which will host the new physical channel adapting the target parameter SIRtarget to the interference I measured on the new physical channel and the type of information to flow on it.

9. Method in accordance with previous claim, characterised in that in the case of an assignment by handover of a new physical channel belonging to the currently serving fixed station, the network may also indicate in the assignment message the power level with which the above message is being transmitted.
